(19) United States
(12) Patent Application Publication
(10) Pub. No.: US 2022/0362979 A1
(43) Pub. Date: Nov. 17, 2022

(54) MOLDING SYSTEMS AND METHODS FOR A PLANETARY GEAR CARRIER

(71) Applicant: ENPLAS CORPORATION, Kawaguchi-shi (JP)

(72) Inventors: Kazuki YAMADA, Kawaguchi-shi (JP); Koki HISAI, Kawaguchi-shi (JP)

(21) Appl. No.: 17/317,493

(22) Filed: May 11, 2021

(51) Int. Cl. B29C 45/27

(52) U.S. Cl. CPC B29C 45/278; B29C 45/2708; B29C 2945/7616; B29C 2945/76829; B29L 2015/003

(57) ABSTRACT

An aspect of mold for producing an end plate of a planetary gear carrier includes a mold body and a cylindrical protrusion extending from a front surface of the mold body. The cylindrical protrusion defines a cylindrical interior space fluidly linked to an interior space of the mold body. The mold also includes an injection gate disposed on a rear surface of the mold body and aligned with a longitudinal axis of the cylindrical protrusion, wherein the injection gate is configured to allow an injection nozzle to inject a molding material into the interior space from an exterior of the mold body. In some aspects, the molding material includes additives that can improve the properties of the resulting molded part. Other aspects of the present disclosure include molded carriers for planetary gear devices, and related processes or methods for making similar molded parts.

### TECHNICAL FIELD

The present disclosure relates to a mold for planetary gear carriers and methods of molding the same.

### BACKGROUND

Planetary gear devices (also known as epicyclic gear devices) are a type of gearing system used to transform rotational motion in machines. These devices are used in many different applications because they are relatively compact and allow for multiple different gear ratio options for transforming rotational motion. Examples of applications of planetary gear devices include motor vehicles (where the term planetary gear box is often used), heavy vehicles (e.g., tractors and excavation equipment), industrial machines, housing equipment. Planetary gear devices may also be reduced in size and used in conjunction with actuators to operate many different mechanisms, including, for example, power back doors (PBD) in vehicles, parking brakes in vehicles, power windows in vehicles, electric shutters or electric blinds for installation and use in vehicles or buildings, such as homes or office buildings.

Planetary gear devices include several different gears that mesh with each other and work together to create a gear ratio that transforms input rotational motion to a desired output rotational motion. These gears are mounted on shafts that are, in turn, mounted to appropriate structural elements (e.g., the planetary gear carrier, the sun gear actuator or output shaft.) The structural elements can be created by an injection molding using a molding material. In particular, a carrier of a planetary gear device may be made using an injection molding process. During a typical injection molding process, a molding material is injected into a mold that may substantially define the structure of the molded part (e.g., the carrier). The locations (e.g., openings in the mold) where the molding material is injected into the mold are called ports or gates. The locations of these gates may be selected based on any of several variables, including how molding material may be distributed evenly in the mold, reducing jetting. The gate locations also result in surface flow marks in the resulting molded part, which limits where the gates can be located in a given mold. In a typical carrier mold, the gates are located on the rear surface of the mold for the carrier and are offset from the protrusions corresponding to the molded planetary gear shafts of the carrier.

However, as will be explained below, the offset gate locations can result in compromised structural integrity of the integrated gear shafts, such as by deformation, warping, cracking, etc. This tendency also may invite increased design tolerances, which can result in increased rejection rates of the resulting molded part, and which may also increase overall cost of materials and manufacturing. Moving the gate locations to align with the protrusions that form the planetary gear shafts can reduce certain deformation such as warping, but also tends to increase the probability of jetting occurring in the molded parts, weakening the overall structure of the molded parts. Thus, there exists a need for improved molding methods for planetary gear carriers that improve part accuracy (consistent shape of molded parts) and production yield.

### BRIEF SUMMARY

An aspect of a molded carrier for a planetary gear device includes a carrier body, an endplate releasably attached to the carrier body, and a plurality of planetary gear shafts disposed on the endplate and extending from the endplate towards the carrier body. The endplate is formed from an injection molding material comprising an additive. The endplate has a plurality of surface flow marks corresponding to the locations of injection molding gates disposed on a rear surface of the endplate, each of the plurality of surface flow marks aligned with an axis of a corresponding planetary gear shaft, respectively.

An aspect of mold for producing an end plate of a planetary gear carrier includes a mold body and a cylindrical protrusion extending from a front surface of the mold body. The protrusion defines a cylindrical interior space fluidly linked to an interior space of the mold body. The mold also includes an injection gate disposed on a rear surface of the mold body and aligned with a longitudinal axis of the protrusion, wherein the injection gate is configured to allow an injection nozzle to inject a molding material into the interior space from an exterior of the mold body.

An aspect of a method of molding an end plate for a planetary gear carrier includes providing a mold for the end plate, where the mold comprises a cylindrical protrusion extending from a front surface of the mold. The aspect further includes injecting a molding material into the mold through an injection gate disposed on a rear surface of the mold and aligned with a longitudinal axis of the protrusion; and cooling the mold to set the molding material.

An aspect of a molded carrier for a planetary gear device includes a carrier body, an endplate releasably attached to the carrier body, and a plurality of planetary gear shafts disposed on the carrier body and extending from the carrier body towards the end plate. The endplate is formed from an injection molding material comprising an additive. The carrier body has a plurality of surface flow marks corresponding to the locations of injection molding gates disposed on a rear surface of the carrier body, each of the plurality of surface flow marks aligned with an axis of a corresponding planetary gear shaft, respectively.

An aspect of mold for producing a carrier body of a planetary gear carrier includes a mold body and a cylindrical protrusion extending from a front surface of the mold body. The protrusion defines a cylindrical interior space fluidly linked to an interior space of the mold body. The mold also includes an injection gate disposed on a rear surface of the mold body and aligned with a longitudinal axis of the protrusion, wherein the injection gate is configured to allow an injection nozzle to inject a molding material into the interior space from an exterior of the mold body.

An aspect of a method of molding a carrier body for a planetary gear carrier includes providing a mold for the carrier body, where the mold comprises a cylindrical protrusion extending from a front surface of the mold. The aspect further includes injecting a molding material into the mold through an injection gate disposed on a rear surface of the mold and aligned with a longitudinal axis of the protrusion; and cooling the mold to set the molding material.

### BRIEF DESCRIPTION OF THE DRAWINGS/FIGURES

The accompanying drawings, which are incorporated herein and form part of the specification, illustrate aspects of the present disclosure and, together with the description, further serve to explain the principles of the disclosure and to enable a person skilled in the relevant art to make and use the disclosure.

FIG. 1 is a perspective view of a planetary gear device according to aspects of the disclosure.

FIG. 2 is a cross section of a planetary gear device as shown in FIG. 1 according to aspects of the disclosure.

FIGS. 3A and 3B are exploded views of a carrier of a planetary gear device according to aspects of the disclosure.

FIG. 4 is a perspective view of a mold for a carrier end plate according to aspects of the disclosure.

FIG. 5 is a cross section of a mold for a carrier end plate according to aspects of the disclosure.

FIGS. 6A and 6B are cross sections of the mold for the carrier end plate of FIG. 5 in different molding states according to aspects of the disclosure.

FIG. 7 is a perspective view of a mold for a carrier end plate according to aspects of the disclosure.

FIG. 8 is a cross section of a mold for a carrier end plate according to aspects of the disclosure.

FIG. 9 is a cross section of the mold for a carrier end plate of FIG. 8 in a molding state according to aspects of the disclosure.

### DETAILED DESCRIPTION

The present disclosure will now be described in detail with reference to aspects thereof as illustrated in the accompanying drawings. References to “one aspect,” “an aspect,” “an example aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspect whether or not explicitly described.

Planetary gear components are typically subject to high stresses and wear during use. They also require relatively tight tolerances for the various components fit together as expected. A tight and correct fit is especially important for proper meshing of the various gear teeth. Injection molding of planetary gear components allows the components to be made quickly and precisely at a relatively low cost. However, in a carrier with integrated planetary gear shafts, the gear shafts may have a tendency to suffer from warping in molds with the typical offset gate locations, which must be taken into account with looser tolerances in the gear shafts and the corresponding shaft holes. Moving the injection gates to align with the axes of the gear shafts may reduce warping, but may in turn introduce jetting into the mold, weakening or otherwise compromising the structural integrity of the carrier.

Planetary gear carriers that have integrated planetary gear shafts are also exposed to significant wear from the planetary gears rotating on the gear shafts. Mitigating this wear is possible through optimal material selection for the carrier. In particular, adding certain additives to the material used to mold the carrier can improve the strength and, ultimately, the service life of the carrier. The typical location used for the molding gates results in molding issues when using these additives to produce an improved carrier. Thus, there exists a need for improved molding methods for planetary gear carriers that are compatible with these types of materials.

An aspect of mold for producing an end plate of a planetary gear carrier may include a mold body and a cylindrical protrusion extending from a front surface of the mold body. The protrusion may define a cylindrical interior space fluidly linked to an interior space of the mold body. The mold may also include an injection gate disposed on a rear surface of the mold body and aligned with a longitudinal axis of the protrusion, configured to allow an injection nozzle to inject a molding material into the interior space from an exterior of the mold body. As will be discussed below, this mold may provide advantages that improve molding precision while also allowing for a wider range of additives to be used in the molding process.

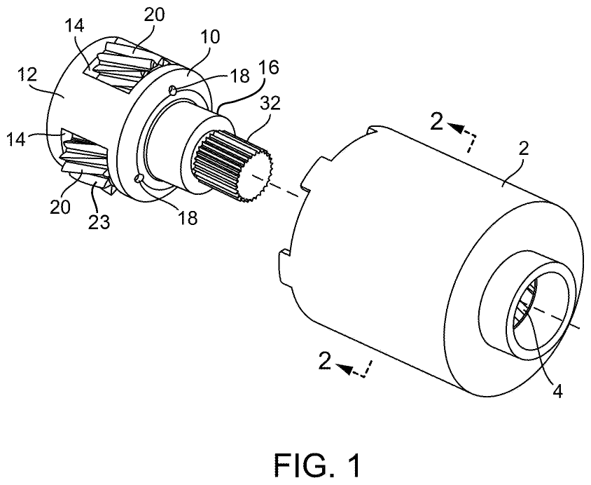

FIG. 1 shows a partially exploded view of a planetary gear device 1. A cylindrical housing 2 is shown along with a carrier 10 that has been removed from housing 2. A plurality of planetary gears 20 are visible mounted in carrier 10. Each planetary gear 20 is rotatably mounted in carrier 10. There may be at least one planetary gears 20 mounted in carrier 10. In some aspects there may be two, three, four, or more planetary gears 20 rotatably mounted in carrier 10. Carrier 10 includes openings 14 in outer surface 12. Openings 14 may be designed as gaps in the circumference of outer surface 12 that correspond to the positions of planetary gears 20. Planetary gears 20, in turn, may be mounted such that teeth 23 of planetary gears 20 extend through opening 14 beyond outer surface 12 of carrier 10 in a radial direction.

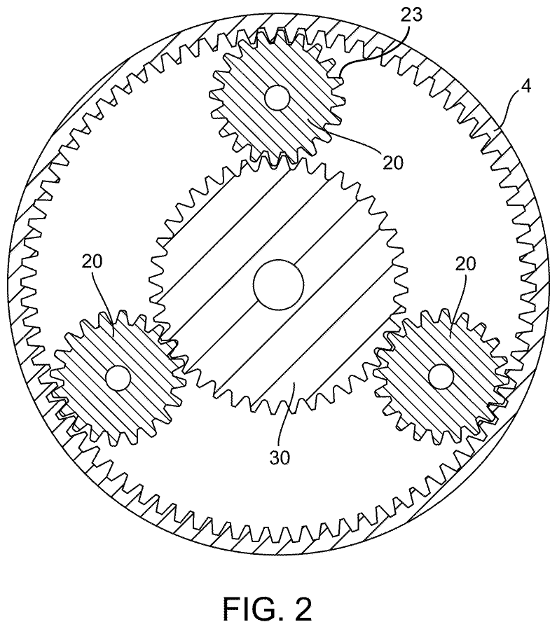

Also shown in FIG. 1 is the output shaft 32. As shown in FIG. 2 (described further below), sun gear 30 may be inserted into a sun gear opening in the center of carrier 10, according to some aspects, such that the teeth of sun gear 30 mesh with the teeth 23 of planetary gear 20. In the aspect shown in FIG. 1, output shaft 32 is embodied in one piece with a carrier 10. Output shaft 32 may have teeth that are integrally formed and configured to output the rotational motion transmitted from the sun gear 30.

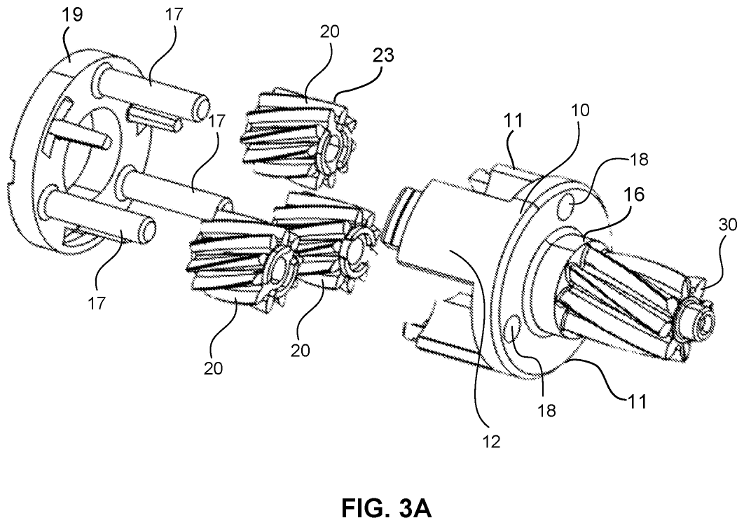

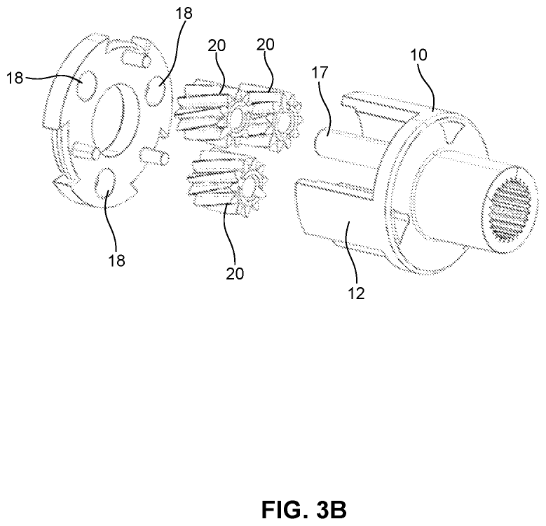

As shown by the dashed axis line, carrier 10 is inserted into housing 2 such that the axis of carrier 10 and the axis of housing 2 are aligned. As shown in FIG. 3, this aspect of carrier 10 includes a boss 16 that extends from the side of carrier 10 opposite the sun gear opening. Boss 16 is received by a corresponding opening in housing 2 or other supporting structure and allows carrier 10 to rotate within housing 2.

FIG. 2 shows a cross section view of housing 2 when the planetary gear device is fully assembled. This view shows an aspect of a gear element of planetary gear device 1: internal gear 4. In this aspect, internal gear 4 is fixed to the inner wall of housing 2. As shown in FIG. 2, once assembled, sun gear 30 located at the center of housing 2 is meshed with planetary gears 20, which are in turn meshed with internal gear 4.

FIGS. 3A and 3B shows an aspect of carrier 10 that includes two separate portions joined together to form carrier 10: a carrier body 11 and an end plate 19. Such an aspect of carrier 10 may improve assembly efficiency by allowing planetary gears 20 to be positioned inside end plate 19 of carrier 10 before joining end plate 19 with carrier body 11 together to form carrier 10. In aspects like those shown in FIGS. 3A and 3B, planetary gear shafts 17 may be integrated into either portion of carrier 10 (i.e., carrier body 11 or end plate 19), while the other portion of carrier 10 may be configured to include corresponding planetary gear shaft holes 18. Planetary gears 20 can be mounted onto planetary gear shafts 17 before joining these corresponding portions of carrier 10, according to some aspects, which may further improve assembly efficiency.

Applications of aspects of planetary gear device 1 include motor vehicles (where the terms “planetary gear box” or “planetary gearbox” may be more often used), heavy vehicles (e.g., tractors, construction, equipment, and excavation equipment), industrial machines, and household equipment, for example. Some aspects of planetary gear device 1 may also be reduced in size and weight, enabling their use in smaller applications. Compact and lightweight aspects of planetary gear device 1 may be used in conjunction with actuators to operate many different mechanisms used in vehicles, including, for example, a power back door (PBD), also known as a power lift gate, power rear hatch, or a power trunk lid; parking brakes, and power windows; and electric shutters or electric blinds for installation and use in vehicles or in buildings (e.g., homes and office buildings).

Planetary gear device 1 as shown in FIGS. 1 and 2 can function in several different ways. For example, providing a rotational input to sun gear 30 and allowing carrier 10 to rotate freely will result in a rotational output being produced housing 2, because internal gear 4 is fixed to housing 2, as shown in the accompanying drawings. The gear ratio that the rotational motion experiences is governed by the number of teeth each gear member has in planetary gear device 1. Changing which components are free to rotate and which components are the input and output alters the gear ratio and how the rotational motion is transformed by planetary gear device 1.

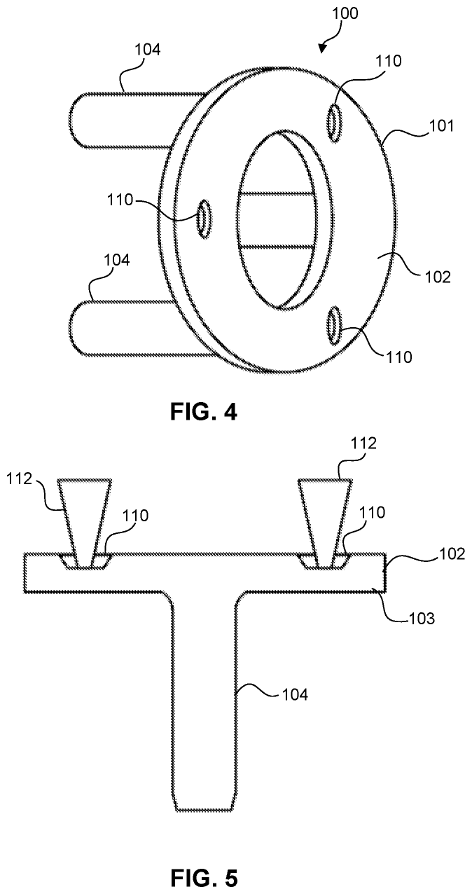

The following discussion refers to the design of female injection molds for the separate portions of carrier 10 with reference to end plate 19. However, the discussion applies equally to a mold for carrier body 11 that has planetary gear shafts 17 in the previously discussed aspects. FIG. 4 shows an example of a typical mold 100 for end plate 19 of carrier 10. Mold 100 is a female mold that defines a space in the interior of mold 100 in the shape of the molded part (i.e., end plate 19 in FIG. 4). Mold 100 comprises a mold body 101. In some aspects, mold body 101 is separable into two or more portions to allow access into the interior of mold 100. A molding material 111 is injected into the interior of mold 100, where it is formed into the desired shape by mold 100 and then allowed set to from the molded part. Suitable molding materials 111 include any material that can be made sufficiently fluid to inject into the mold and can then be set into a final solid shape. Examples of suitable molding materials include plastics, and in particular thermoplastics such as acrylonitrile butadiene styrene (ABS), polyethylene, polycarbonate, nylon, polystyrene, and/or other equivalent thermoplastic polymers, in some aspects of the present disclosure. Mold 100 may be made from any material that can be shaped to accurately produce the external features of end plate 19 and to withstand the wear of repeated molding cycles. For example, mold 100 may be made from a suitable metal, such as stainless steel or aluminum.

Injection gates 110 are shown at locations on a rear surface 102 of mold 100 at locations circumferentially offset from protrusions 104, which are the elements of mold 100 that correspond to planetary gear shafts 17 of end plate 19. As shown in FIG. 4, protrusions 104 are cylindrical protrusions that are internally linked to mold body 101. In this aspect of typical mold 100, there are three gates 110, each of which is placed between pairs of protrusions 104. Injection gates 110 are openings in mold 100 that are shaped to receive injection molding material 111 from a suitable source, such as an injection molding nozzle 112. There may be any number of desired protrusions 104 and corresponding gates 110 depending on the design of end plate 19.

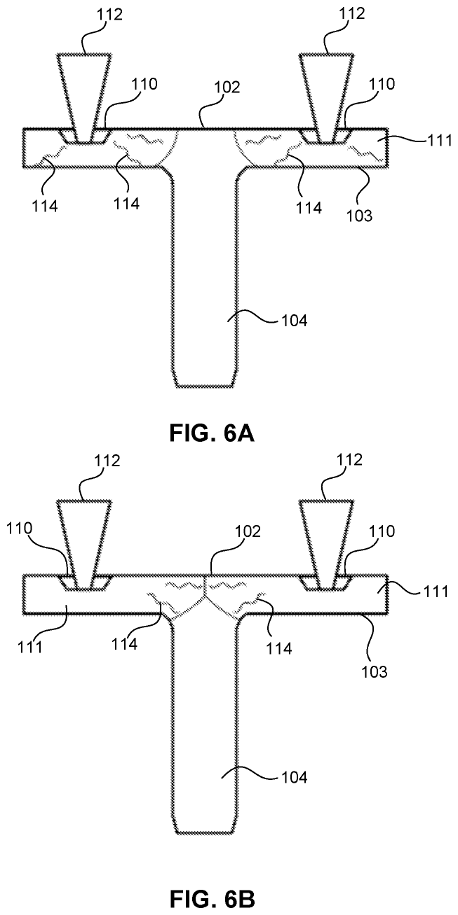

As discussed above, this placement of gates 110 minimizes or avoids jetting when molding material 111 is injected into mold 100. However, this placement of gates 110 can lead to warping of protrusions 104 (and corresponding planetary gear shafts 17). Larger tolerances may be used in order to accommodate the possibility of warping, which may otherwise reduce assembly tightness and/or increase wear on the mold or molded parts. The warping is caused by how the injection molding material 111 spreads through mold 100 from gates 110. FIGS. 5, 6A, and 6B show a cross-sectional view of mold 100 with gates 110 offset from the single example of protrusion 104 shown in this view. FIGS. 6A and 6B show injection molding material 111 being injected into mold 100 at different stages of the injection process. As seen in FIG. 6A, as injection molding begins, molding material 111 fills the area between rear surface 102 and front surface 103, and spread laterally towards protrusion 104. FIG. 6B shows a later stage of injection where expanding molding material 111 meets at the centerline of protrusion 104 because gates 110 are spaced an equal distance from protrusion 104. Molding material 111 may then flow downwards and fill protrusion 104. However, in practice, molding material 111 may not meet precisely at the centerline. Slight differences in the distance of each of gates 110 from protrusion 104, differences in material fill rates from injection molding nozzles 112, and other variables may result in uneven filling of mold 100 from each gate 110. This, in turn, means that protrusions 104 are filled by more molding material 111 from one of gates 110, which can result in warping because the off-centerline filling of protrusion 104.

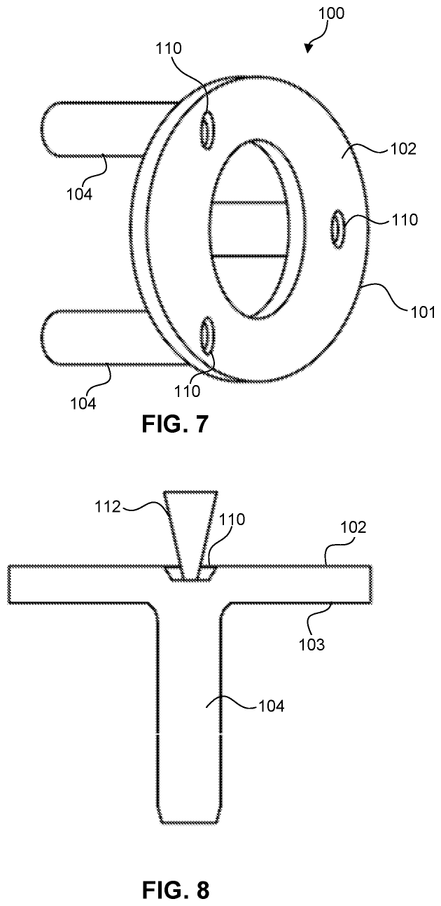

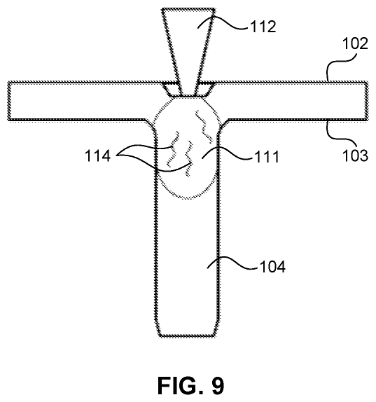

In an aspect of the disclosure as shown in FIG. 7, gates 110 can be placed on the centerline or longitudinal axis of each protrusion 104. For example, in the aspect shown in FIG. 7, there are three protrusions 104, and three corresponding gates 110. There may be more or less protrusion 104 and gate 110 pairings depending on the design of mold 100. An advantage of aspects such as those shown in FIG. 7 is that the warping discussed above with offset gate 110 locations may be reduced or eliminated as a result of molding material 111 is being injected along the centerline of protrusions 104.

However, as discussed above, placing gates 110 as shown in FIG. 7 results in jetting issues that can create flow marks in the resulting molded part. This problem is solved in aspects as shown in FIG. 7 by the addition of additives to molding material 111. Additives can be small particles or fibers of solid material that differ from the injection molding material 111. Some examples of materials that may be used as additives are glass fibers, carbon fibers, inorganic fillers such as mica, silica, talc, metal fibers, wood flour, or a combination thereof. These additives are blended into liquid injection molding material 111 prior to injecting molding material 111 into mold 100. The addition of certain additives may reduce or avoid jetting problems when gates 110 are aligned with protrusions 104 because the additives enhance the mixing of molding material 111, which promotes even filling of mold 100. Using additives in this manner may also yield more favorable results with use of this configuration of gates 110, reducing warping that may occur with offset gates 110, while avoiding cavitation issues otherwise caused by the aligned gates 110.

A further advantage of aligning gates 110 with protrusions 104 involves the use of additives to improve the properties of the resulting molded part. Additives can be used to improve the physical characteristics of a molded part. In a molded part like end plate 19, improving wear resistance is particular desirable because doing so directly increases service life of the part. Additives can be added to molding material 111 to increase surface hardness and resistance to wear. In some aspects, the additives are small glass fibers 114. Using glass fibers 114 with offset gate locations such as those shown in FIGS. 5 and 6A-6B results in significant numbers of the glass fibers being oriented at different angles with respect to the longitudinal axis of protrusion 104, due to glass fibers 114 entering protrusion 104 at angles resulting from the offset locations of gates 110. However, in aspects of mold 100 with gates 110 aligned with protrusions 104, the glass fibers may be injected into mold 100 and protrusion 104 oriented in the same direction relative to mold 100. This configuration may result in improved wear resistance of planetary gear shafts 17 because of the axially-aligned orientation of glass fibers 114 in the resulting end plate 19.

A method of manufacturing a molded part according to aspects of the present disclosure begins with providing mold 100 according to aspects discussed above. In particular, aspects of mold 100 having injection gates 110 aligned with protrusions 104 can be used in this molding method. Suitable injection molding material 111 may be injected into injection gates 110 until mold 100 is filled with molding material 111. In some aspects, an additive is added to injection molding material 111 before injection. Injection may occur at an elevated temperature that is above the melting point of the injection molding material 111. After filling mold 100, injection gates 110 can be capped or closed off. Mold 100 is then treated to solidify molding material 111 in mold 100 into the molded part. In some aspects, the setting step includes cooling mold 100, either through passive air-cooling or by actively circulating a cooling fluid around the exterior of mold 100. After the setting step, mold 100 is separated and the molded part is extracted. In some aspects, the molded part can be an end plate 19 of a carrier 10.

Some advantages of aspects discussed above may include producing a molded part with reduced warping caused by locating injection gates 110 relative to the protrusions 104. Other advantages may include improved wear resistance from the use of glass fibers 114 as an additive, and in particular the orientation of glass fibers 114 created by the use of aligned injection gates 110.

It is to be appreciated that the Detailed Description section, and not the Summary and Abstract sections, is intended to be used to interpret the claims. The Summary and Abstract sections may set forth one or more, but not all, example aspects of the present disclosure as contemplated by the inventor(s), and thus, are not intended to limit the present disclosure and the appended claims in any way.

The foregoing description of the specific aspects will so fully reveal the general nature of the disclosure that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described example aspects, but should be defined only in accordance with the following claims and their equivalents.

What is claimed is:

1. A molded carrier for a planetary gear device, comprising:
a carrier body;
an endplate releasably attached to the carrier body; and
a plurality of planetary gear shafts disposed on the endplate and extending from the endplate towards the carrier body,
wherein the endplate is formed from an injection molding material comprising an additive, and
wherein the endplate has a plurality of surface flow marks corresponding to the locations of injection molding gates disposed on a rear surface of the endplate, each of the plurality of surface flow marks aligned with an axis of a corresponding planetary gear shaft, respectively.

2. The molded carrier of claim 1, wherein the additive comprises glass fibers.

3. The molded carrier of claim 1, wherein the plurality of planetary gear shafts consists of three planetary gear shafts, and wherein the plurality of surface flow marks consists of three surface flow marks.

4. A mold for producing an end plate of a planetary gear carrier, comprising:
a mold body;
a cylindrical protrusion extending from a front surface of the mold body, wherein the protrusion defines a cylindrical interior space fluidly linked to an interior space of the mold body; and
an injection gate disposed on a rear surface of the mold body and aligned with a longitudinal axis of the cylindrical protrusion, wherein the injection gate is configured to allow an injection nozzle to inject a molding material from outside the mold body into the interior space of the mold body.

5. The mold of claim 4, further comprising:
a plurality of cylindrical protrusion, each of which extends from the front surface of the mold body, wherein each cylindrical protrusion of the plurality of cylindrical protrusions defines a cylindrical interior space fluidly linked to the interior space of the mold body; and
a plurality of injection gates disposed on the rear surface of the mold body and aligned with at least one corresponding longitudinal axis of at least one of the cylindrical protrusions of the plurality of the cylindrical protrusions, respectively, wherein each injection gate of the plurality of injection gates is configured to allow the injection nozzle to inject the molding material into the interior space from the exterior of the mold body.

6. The mold of claim 5, wherein each injection gate of the plurality of injection gates is aligned with a corresponding longitudinal axis of a corresponding cylindrical protrusion of the plurality of cylindrical protrusions.

7. A method of molding an end plate for a planetary gear carrier, the method comprising:
providing a mold for the end plate, wherein the mold comprises a cylindrical protrusion extending from a front surface of the mold;
injecting a molding material into the mold through an injection gate disposed on a rear surface of the mold, wherein the injection gate is aligned with a longitudinal axis of the cylindrical protrusion; and
cooling the mold to set the molding material.

8. The method of claim 7, wherein the mold comprises three cylindrical protrusions including the cylindrical protrusion of claim 7, each cylindrical protrusion extending from the front surface of the mold and three injection gates, each injection gate disposed on the rear surface of the mold and aligned with a longitudinal axis of a corresponding cylindrical protrusion of the three cylindrical protrusions, respectively, and
wherein the injecting further comprises injecting the molding material into each of the three injection gates.

9. The method of claim 7, further comprising:
adding an additive to the molding material before or during the injecting, wherein the additive is configured to reduce formation of voids in the mold during the injecting step.

10. The method of claim 9, wherein the additive comprises glass fibers.

11. A molded carrier for a planetary gear device, comprising:
a carrier body;
an endplate releasably attached to the carrier body; and
a plurality of planetary gear shafts disposed on the carrier body and extending from the carrier body towards the end plate,
wherein the carrier body is formed from an injection molding material comprising an additive, and
wherein the carrier body has a plurality of surface flow marks corresponding to the locations of injection molding gates disposed on a rear surface of the carrier body, each of the plurality of surface flow marks aligned with an axis of a corresponding planetary gear shaft, respectively.

12. The molded carrier of claim 11, wherein the additive comprises glass fibers.

13. The molded carrier of claim 11, wherein the plurality of planetary gear shafts consists of three planetary gear shafts, and wherein the plurality of surface flow marks consists of three surface flow marks.

14. A mold for producing a carrier body of a planetary gear carrier, comprising:
a mold body;
a cylindrical protrusion extending from a front surface of the mold body, wherein the protrusion defines a cylindrical interior space fluidly linked to an interior space of the mold body; and
an injection gate disposed on a rear surface of the mold body and aligned with a longitudinal axis of the cylindrical protrusion, wherein the injection gate is configured to allow an injection nozzle to inject a molding material from outside the mold body into the interior space of the mold body.

15. The mold of claim 14, further comprising:
a plurality of cylindrical protrusion, each of which extends from the front surface of the mold body, wherein each cylindrical protrusion of the plurality of cylindrical protrusions defines a cylindrical interior space fluidly linked to the interior space of the mold body; and
a plurality of injection gates disposed on the rear surface of the mold body and aligned with at least one corresponding longitudinal axis of at least one of the cylindrical protrusions of the plurality of the cylindrical protrusions, respectively, wherein each injection gate of the plurality of injection gates is configured to allow the injection nozzle to inject the molding material into the interior space from the exterior of the mold body.

16. The mold of claim 15, wherein each injection gate of the plurality of injection gates is aligned with a corresponding longitudinal axis of a corresponding cylindrical protrusion of the plurality of cylindrical protrusions.

17. A method of molding carrier body for a planetary gear carrier, the method comprising:
providing a mold for the carrier body, wherein the mold comprises a cylindrical protrusion extending from a front surface of the mold;
injecting a molding material into the mold through an injection gate disposed on a rear surface of the mold, wherein the injection gate is aligned with a longitudinal axis of the cylindrical protrusion; and
cooling the mold to set the molding material.

18. The method of claim 17, wherein the mold comprises three cylindrical protrusions including the cylindrical protrusion of claim 17, each cylindrical protrusion extending from the front surface of the mold and three injection gates, each injection gate disposed on the rear surface of the mold and aligned with a longitudinal axis of a corresponding cylindrical protrusion of the three cylindrical protrusions, respectively, and
wherein the injecting further comprises injecting the molding material into each of the three injection gates.

19. The method of claim 17, further comprising:
adding an additive to the molding material before or during the injecting, wherein the additive is configured to reduce formation of voids in the mold during the injecting step.

20. The method of claim 19, wherein the additive comprises glass fibers.
